(19) United States
(12) Patent Application Publication
(10) Pub. No.: US 2005/0140564 A1
(43) Pub. Date: Jun. 30, 2005

(54) Loop antenna

(75) Inventors: Futoshi Deguchi, Fukuoka-shi (JP); Yoshitaka Mizoguchi, Fukuoka-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/974,031

(22) Filed: Oct. 27, 2004

(30) Foreign Application Priority Data
Oct. 29, 2003 (JP) 2003-368667
Nov. 14, 2003 (JP) 2003-384928

(51) Int. Cl. H01Q 11/12; H01Q 7/00

(52) U.S. Cl. 343/866; 343/741

(57) ABSTRACT

It is an object of the invention to provide a loop antenna constituted by a single element which can apply a magnetic field to carry out a communication reliably with high precision irrespective of the position and direction of a radio communication medium.

The invention provides a loop antenna 1 including a conductor 2, a plurality of bending portions 50 provided on the conductor 2, and a feeding portion for supplying a signal current to the conductor 2, the conductor being turned circumferentially like a loop by setting the feeding portion to be a base point, wherein the conductor 2 forms a three-dimensional space. Consequently, it is possible to generate a magnetic field to all dimensions, thereby carrying out a communication irrespective of the position and direction of a radio communication medium.

### BACKGROUND OF THE INVENTION

1. Field of the Invention

The present invention has an object to provide a loop antenna which is optimum for use in a radio communication medium processing device for supplying a power and send data to a radio communication medium such as a non-contact IC card or an IC tag which is to be accommodated in a rack, a box or a basket and acquiring receive data from the radio communication medium.

2. Description of the Related Art

In order to carry out an authentication and a baggage destination distribution, there are often used a radio communication medium having an ID code such as an IC card or an IC tag and a radio communication medium processing device for performing the IC code authentication of the radio communication medium. When a radio on-board medium is present within the communication range of a communication on-board medium processing device, an induction voltage is generated on an antenna possessed by the radio communication medium through a magnetic field applied from the antenna and is rectified so that a power and send data are supplied. In the radio communication medium to which the power is supplied, a switch is turned ON/OFF corresponding to 1 or 0 of data by a modulating circuit including a load resistor connected to an antenna and the switch, for example, according to data read from a mounted memory. By the ON/OFF operation, a load fluctuation for the antenna possessed by the radio communication medium is caused and is transmitted as a signal to an antenna on the radio medium processing device side. The transmitted signal is demodulated so that an ID code authentication thereof is executed (for example, see JP-A-2000-163523 Publication).

By attaching the radio communication medium to products such as books, chemicals or daily necessities and using the radio communication medium processing device for the products, it is possible to confirm a stock.

Therefore, there has been used the radio communication medium processing device having an antenna to carry out a communication with the product having the radio communication medium for a merchandise management.

However, an antenna to be used in a conventional radio communication medium processing device is a bar-shaped antenna or a planar antenna, and there is a problem in that a communication range with the radio communication medium is insufficient. For example, in an ordinary bar-shaped rod antenna, there is a problem in that a range for the generation of a magnetic field is not three-dimensional and the magnetic field cannot be received depending on the position and direction of the radio communication medium, resulting in no communication with the radio communication medium.

In the case in which the radio communication medium is attached to a product and they are put in a rack or a basket to carry out the merchandise management, particularly, a conventional antenna has a problem in that a magnetic field cannot be supplied and the radio communication medium cannot be recognized depending on the position and direction of the radio communication medium. For this reason, there is a problem in that the merchandise management with high precision cannot be carried out for the product present in the rack or the basket or the installation position and direction of the radio communication medium is greatly restricted to carry out the merchandise management.

Further, with a conventional structure, however, an ordinary radio communication medium processing device has a problem in that a communication range with a radio communication medium is small and a communication cannot be carried out depending on the direction of the radio communication medium, resulting in an insufficient communication. Because the communication is insufficient, moreover, there is a problem in that the recognition of the accommodated goods is insufficient. For this reason, the radio communication medium processing device is insufficiently used for the merchandize management.

Consequently, it is especially hard to carry out a merchandize management through an exchange with the radio communication medium in a storage rack or storage box for accommodating goods according to a desirable manner of the merchandize management.

In the case in which the merchandize management is to be carried out using the radio communication medium processing device independently for each rack or box, and at the same time, a plurality of racks or boxes is to be provided to perform the merchandize management in parallel respectively, moreover, there is also a problem in that a radio communication medium stored in an adjacent rack is read erroneously. Therefore, an application to the merchandize. management is insufficient. There is a problem in that the erroneous recognition of goods having a radio communication medium attached thereto which are accommodated in a surrounding rack or box is increased still more when the power of the device is raised to enhance a communication capability.

In order to cope with the problems, it is necessary to vary a communication frequency for each radio communication medium processing device. A frequency band which can be used is determined and is hard realistically.

### SUMMARY OF THE INVENTION

In consideration of the problems, it is an object of the invention to provide a loop antenna which can be used optimally for the merchandise management and can recognize a radio communication medium present in a rack or a basket with high precision.

In consideration of the problems, it is an object of the invention to provide a radio communication medium processing device which can be optimally used for a merchandise management and can carry out the merchandize management for each rack or box in which goods are accommodated.

The invention provides a loop antenna having a conductor, and a plurality of bending portions provided on the conductor, the conductor being turned circumferentially like a loop with a feeding portion to be a base point, wherein the conductor forms a three-dimensional space.

By such a structure, a magnetic field generated by the loop antenna can generate a magnetic field in all axial directions in the three-dimensional space. The magnetic field can be applied irrespective of the position and direction of the radio communication medium present in a space surrounded by the loop antenna. Consequently, a communication with the radio communication medium can be carried out reliably.

The loop antenna is set to be almost U or Z shaped as seen from an optional axis in the three-dimensional space. Consequently, it is possible to apply a magnetic field irrespective of the direction and position of the radio communication medium present in a space formed by the loop antenna. Thus, the communication with the radio communication medium can be carried out reliably.

Moreover, a part of the conductor takes the shape of an arc. Consequently, the strength of the loop antenna can be increased.

By causing the loop antenna to take various shapes, furthermore, it is possible to form a loop antenna corresponding to the shape of a rack, a box or a basket which uses the same.

By storing the loop antenna in a rack-shaped member or a housing to constitute the radio communication medium processing device, moreover, it is possible to carry out a recognition irrespective of the direction and position of the radio communication medium present in the rack-shaped member or the housing and to also perform an automatic merchandize management.

The invention provides a radio communication medium processing device comprising, a housing having an opening portion; the loop antenna according to claim 1 which is provided in the housing or in a member forming the housing; and a reading/writing portion for reading and/or writing data from/to a radio communication medium through the loop antenna.

By such a structure, a radio communication loading medium accommodated in a housing such as a box or a rack can carry out a communication irrespective of a position and a direction in the housing so that a merchandise management can be performed reliably. In particular, a magnetic field generated from the antenna in the housing is applied to all of an X axis, a Y axis and a Z axis. Consequently, the communication disable range of the radio communication medium can be caused to be rarely generated. Furthermore, it is possible to enhance precision in the merchandize management.

Moreover, the erroneous recognition of the radio communication medium accommodated in the adjacent housing is prevented. Consequently, it is also possible to set a radio communication medium processing device to be one unit and to assemble a plurality of units to be used. Furthermore, a communication with the radio communication medium can be carried out in a plurality of radio communication medium processing device units thus assembled, thereby performing the merchandise management. The result can be transmitted to a host in parallel on each of the radio communication medium processing device units. Thus, an efficient system can be constituted.

### BRIEF DESCRIPTION OF THE DRAWINGS

FIG. 1 is a perspective view showing a loop antenna according to a first embodiment of the invention,

FIG. 2 is a perspective view showing the loop antenna according to the first embodiment of the invention,

FIG. 3 is a perspective view showing the loop antenna according to the first embodiment of the invention,

FIG. 4 is a perspective view showing the loop antenna according to the first embodiment of the invention,

FIG. 5 is a perspective view showing the loop antenna according to the first embodiment of the invention, and

FIG. 6 is a perspective view showing a radio communication medium processing device according to a second embodiment of the invention.

FIG. 7(a) is a perspective view showing a radio communication medium processing device according to a first embodiment of the invention and FIG. 7(b) is a sectional view taken along A-A′ in (a),

FIG. 8 is a perspective view showing an antenna incorporated in the radio communication medium processing device according to the first embodiment of the invention,

FIG. 9 is a perspective view showing the antenna incorporated in the radio communication medium processing device according to the first embodiment of the invention,

FIG. 10 is a perspective view showing the antenna incorporated in the radio communication medium processing device according to the first embodiment of the invention,

FIG. 11 is a perspective view showing the antenna incorporated in the radio communication medium processing device according to the first embodiment of the invention,

FIG. 12(a) is a perspective view showing the radio communication medium processing device according to the first embodiment of the invention and FIG. 12(b) is a sectional view taken along B-B′ in (a),

FIG. 13(a) is a perspective view showing the radio communication medium processing device according to the first embodiment of the invention and FIG. 13(b) is a sectional view taken along C-C′ in (a),

FIG. 14 is a perspective view showing an electric field shield according to the first embodiment of the invention,

FIG. 15 is a view showing the structure of a radio communication medium processing system according to a second embodiment of the invention, and

FIG. 16 is a view showing the structure of the radio communication medium processing system according to the second embodiment of the invention.

### DESCRIPTION OF THE PREFERRED EMBODIMENTS

Embodiments of the invention will be described below with reference to the drawings.

A radio communication medium in the invention is a medium capable of carrying out a communication with a processing device in non-contact through a non-contact IC card, an IC tag, an ID tag, an identification label or an RF-ID tag, and the processing device serves to carry out a communication with these radio communication media, that is, includes a reader, a reader/writer and a reading/writing device.

### First Embodiment

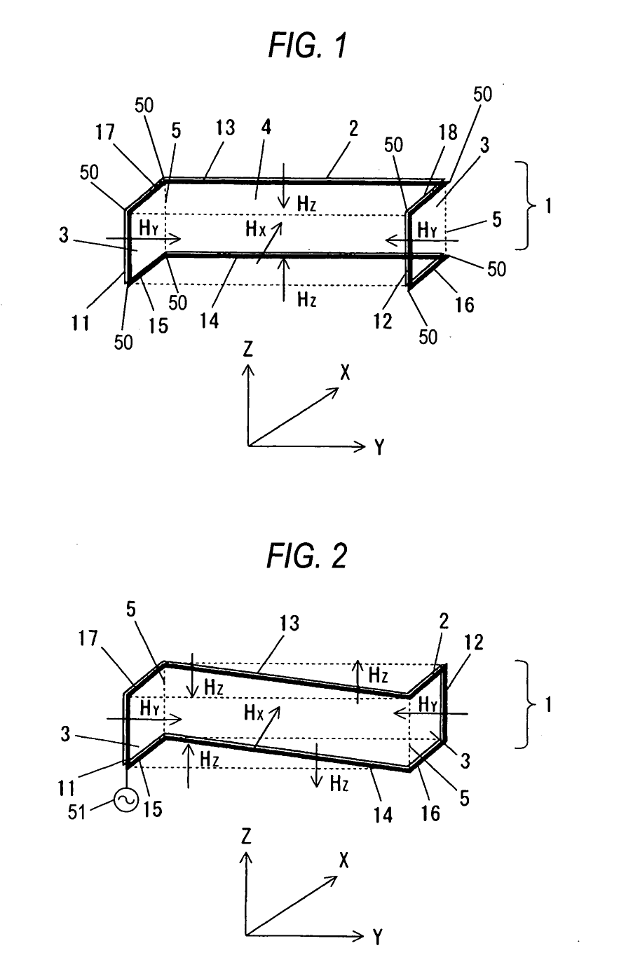

FIGS. 1, 2, 3, 4 and 5 are perspective views showing a loop antenna according to a first embodiment of the invention. A loop antenna formed by a conductor turned circumferentially like a loop is illustrated.

1 denotes a loop antenna, 2 denotes a conductor, 3 denotes two opposed surfaces, 4 denotes a surface interposed between the opposed surfaces 3, 5 denotes an intersection, 11, 12, 13, 14, 15, 16, 17 and 18 denote a part of the conductor 2, 50 denotes a bending portion, and 51 denotes a feeding portion. H_{X} denotes a magnetic field generated in an X-axis direction, H_{Y} denotes a magnetic field generated in a Y-axis direction, and H_{Z} denotes a magnetic field generated in a Z-axis direction. The feeding portion 51 is formed on the end of the conductor 2, and the conductor 2 is formed with a circumferential turn like a loop by setting the feeding portion 51 to be a base point and a signal current is supplied from the feeding portion 51 thereto. Moreover, a reading/writing portion is connected to the feeding portion 51, and a signal current is output to the loop antenna 1 or a signal is received and demodulated.

Furthermore, the loop antenna 1 is turned circumferentially with a plurality of bending portions 50 in the middle of the conductor 2 in such a manner that a virtual space formed by the conductor 2 is a three-dimensional space. Since the virtual space formed by the conductor 2 becomes the three-dimensional space, moreover, the center of gravity of the virtual space is present in the region of the three-dimensional space and is not present like a plane. More specifically, the loop antenna 1 has such a shape that all of the conductors 2 are not present over the same plane.

Moreover, bending is carried out through the bending portions 50. Consequently, the opening surface of the loop antenna 1 created by looping the conductor 2 is not present on only the same plane but is provided across different planes which are mutually inclined over the three-dimensional space. Furthermore, the conductor 2 is formed with the opening surface present on a first optional surface, and second and third surfaces opposed to each other at both ends. The first surface is the surface 4 to be interposed, and the second and third surfaces are equivalent to the opposed surfaces 3.

Referring to the parts 11 to 18 of the conductor 2, moreover, the parts 15, 17, 16 and 18 of the conductor 2 are formed in the X-axis direction, and the parts 13 and 14 of the conductor 2 are formed along a Y axis and the parts 11 and 12 of the conductor 2 are formed along a Z axis.

The loop antenna 1 can be provided in a hexahedron space, and furthermore, another polyhedral space, or an elliptical sphere or spherical space. Therefore, the loop antenna 1 can be accommodated in the housing having an opening portion connecting an internal space to an external space which is used for a rack, for example, and can be thus utilized. Consequently, it is possible to easily carry out a communication with a radio communication medium present in the housing.

The conductor 2 is formed by a material for conducting a signal current and various metals are used therefor. In consideration of a balance with a strength obtained by the bending portion 50, steel, stainless or aluminum is suitable and other materials may be used. Moreover, the conductor 2 is provided with a plurality of bending portions 50. The bending portion 50 includes a bending portion 50 to be bent over a three-dimensional space in addition to a bending portion 50 to be bent over a two-dimensional plane. Furthermore, the bending portion 50 may be formed angularly to have a right angle, an obtuse angle or an acute angle or may be formed like a curve, an arc or a curved line to draw a smooth curve. More specifically, the bending portion 50 has various shapes so that the loop antenna 1 is formed with an angular shape, may be formed with a round shape or may be formed by a smooth curved line.

A plurality of bending portions 50 is present in the conductor 2 so that the conductor 2 of the loop antenna 1 is turned circumferentially through a three-dimensional space. More specifically, the opening surface of the loop antenna 1 is not only present on the same two-dimensional plane but also in an inclined three-dimensional space. In other words, the opening surface of the loop antenna 1 is provided across the three-dimensional space by the bending of the conductor 2. Consequently, the opening surface which is opened in a different axial direction is formed with a circumferential turn having the bending portion 50 of the conductor 2 of the loop antenna 1. For example, the space surrounded by the looped conductor 2 becomes a hexahedral space. For instance, the opposed surfaces 3 and the surface 4 interposed therebetween are generated with a mutual inclination. Consequently, a magnetic field can be generated in the vector directions of all the three-dimensional spaces of the X axis, the Y axis and the Z axis.

As shown in FIG. 1, moreover, the conductor 2 has such a shape as to connect each vertex of the hexahedral space surrounded by the conductor 2 and to turn circumferentially to be looped in a single stroke. Consequently, any of the parts 11 to 18 of the conductor 2 always sets any of the X axis, the Y axis and the Z axis to be a direction vector thereof. As will be described below, thus, a magnetic field can be generated in all of the three-dimensional spaces of the X axis, the Y axis and the Z axis.

Furthermore, the conductor 2 also takes such a shape as to connect outer peripheral sides provided across three surfaces including the optional opposed surfaces 3 and the surface 4 interposed between the opposed surfaces 3 in the hexahedron space surrounded by the conductor 2. Consequently, any of the parts 11 to 18 of the conductor 2 always sets any of the X axis, the Y axis and the Z axis to be a direction vector thereof. Consequently, a magnetic field can be generated in all of the three-dimensional spaces of the X axis, the Y axis and the Z axis in the same manner.

Similarly, the conductor 2 takes such a shape that the parts 11 to 18 of the conductor 2 are present on each side excluding the intersection 5 over the optional opposed surfaces 3 and the surface 4 interposed therebetween. In the same manner, any of the parts 11 to 18 of the conductor 2 always takes such a shape that any of the X axis, the Y axis and the Z axis is set to be a direction vector thereof. Consequently, a magnetic field can be generated in all of the three-dimensional spaces of the X axis, the Y axis and the Z axis in the same manner.

More specifically, the loop antenna 1 can apply the magnetic field to all of the X axis, the Y axis and the Z axis which are the three-dimensional vectors in an optional space.

Next, description will be given to the exchange operation of the loop antenna 1 with the radio communication medium.

A necessary signal current is supplied from the reading/writing portion to the loop antenna 1. A magnetic field is generated from the conductor 2 through the supplied signal current. At this time, the conductor 2 is formed by the parts 11 to 18 of the conductor 2 which are present between the bending portions 50 respectively, and an eddy magnetic field setting a signal current vector to be a reference is generated in each of the parts of the conductor 2. More specifically, the magnetic field H_{X} in the X-axis direction is generated from the parts 11, 12, 13 and 14 of the conductor 2. The magnetic field H_{Y} in the Y-axis direction is generated from the parts 11, 15 and 17, and 12, 16 and 18 of the conductor 2. Similarly, the magnetic field H_{Z} in the Z-axis direction is generated from the parts 14, 15 and 16, and 13, 17 and 18 of the conductor 2.

In the case in which a radio communication medium such as an IC tag or an IC card is present in the space surrounded by the loop antenna 1 or on a periphery thereof, an induction electromotive force is generated over an internal antenna incorporated in the radio communication medium upon receipt of the magnetic field generated from the conductor 2. Consequently, a power and signal data are supplied to an IC incorporated in the radio communication medium. A load fluctuation is generated in a modulating circuit constituted by a switch and a load circuit corresponding to data transmitted from a loaded memory in the radio communication medium to which the power is supplied. The load fluctuation is transmitted to the loop antenna 1 through a mutual inductance. In the loop antenna 1, the load fluctuation is received as a signal and is transmitted as a received signal to the reading/writing portion. In the reading/writing portion, the signal is demodulated and an error detection is also carried out if necessary so that the signal is analyzed. As a result of the analysis, it is possible to authenticate an ID code possessed by the radio communication medium.

The magnetic field generated from the conductor 2 is generated in all of the directions of the X axis, the Y axis and the Z axis. Therefore, any magnetic field is always added irrespective of the direction and position of the radio communication medium. For example, the effective range of the magnetic field is more enlarged by the magnetic field generated from the parts 11, 15 and 17 of the conductor 2 which are bent and protruded. Consequently, the magnetic field can be given reliably irrespective of the position of the radio communication medium. In the case in which the magnetic field generated by the conductor 2 is applied in only at least one of the directions of the X axis and the Y axis, moreover, a magnetic field cannot be applied to the radio communication medium put in a parallel direction with the magnetic field. However, the loop antenna 1 generates a magnetic field in any of the directions of the X axis, the Y axis and the Z axis. Therefore, the direction of the radio communication medium is not completely parallel with the magnetic fields in all of the directions. Consequently, the direction of the radio communication medium to which the magnetic field is not applied is gone so that the communication with the radio communication medium can be carried out reliably through the loop antenna 1.

For this reason, in the case in which a product having the radio communication medium attached thereto is put in a structure having an internal space and an opening portion connecting the internal space to an external space which is used optimally in a rack or a basket such as a housing, the loop antenna 1 can be caused to be optimum for use in the radio communication medium processing device capable of carrying out a merchandize management through the communication with the radio communication medium. If the loop antenna 1 can apply a magnetic field to all of the X axis, the Y axis and the Z axis, it is provided in the housing so that a magnetic field can be applied irrespective of the position and direction of the radio communication medium present in the internal space. Thus, precision in a communication and a reliability can be enhanced remarkably.

A magnetic plate is provided on the outside of the loop antenna 1. Consequently, it is possible to constitute a closed circuit in a magnetic field. It is also possible to converge the magnetic field on the internal space of the loop antenna 1. Moreover, an electric field shield is provided around the conductor 2 of the loop antenna 1. Consequently, it is possible to prevent the leakage of an electric field while applying the magnetic field and to inhibit the influence of the electric field on surroundings. The electric shield to be used has a bag-shaped conductor and is comb-shaped.

FIG. 2 illustrates the loop antenna 1 having a different loop shape of the conductor 2. 5 denotes a reference side. Moreover, the loop antenna 1 in FIG. 2 takes an almost Z shape as seen from the Z-axis direction in the case in which the X axis, the Y axis and the Z axis are put in directions shown in FIG. 2.

The conductor 2 illustrated in FIG. 2 has a plurality of bending portions in the same manner as that shown in FIG. 1, and a region space formed by the conductor 2 is generated in a three-dimensional space. In particular, the parts 13 and 14 of the conductor 2 are formed on a diagonal line connecting the reference sides 5 to be line symmetrical in the opposed surfaces 3, and the parts 11, 12, 15, 16, 17 and 18 of the conductor 2 are formed on the residual sides of the opposed surfaces 3. Consequently, the parts of the conductor 2 having all of the directions of the X axis, the Y axis and the Z axis are formed on the portions of the conductor 2.

Also in the loop antenna 1 having the shape of the conductor 2, the magnetic field H_{X} in the direction of the X axis is generated by the parts 11, 12, 13 and 14 of the conductor 2, the magnetic field H_{Y} in the direction of the Y axis is generated by the parts 11, 14 and 17, and 12, 16 and 18 of the conductor 2, and the magnetic field H_{Z} in the direction of the Z axis is generated by the parts 14, 15 and 16, and 13, 17 and 18 of the conductor 2. As described above, the magnetic field can be applied to each of the X axis, the Y axis and the Z axis in the three-dimensional region formed by the loop antenna 1, and the magnetic field can be applied irrespective of the position and direction of the radio communication medium present in the same region. Consequently, it is possible to carry out a communication with high precision irrespective of the position and direction of the radio communication medium.

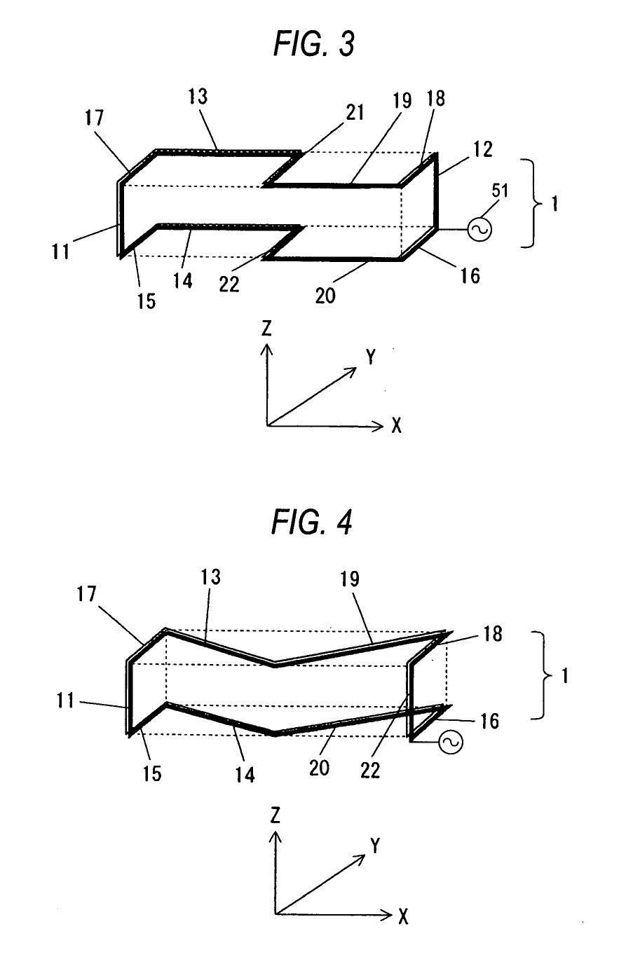

FIG. 3 shows the loop antenna 1 having a further shape.

The conductor 2 of the loop antenna 1 in FIG. 3 has a plurality of bending portions 50, and a region space formed by the conductor 2 is generated in a three-dimensional space. At this time, parts 21 and 22 of the conductor 2 are almost parallel with the opposed surfaces 3 and are formed on a part of the sides of the surface present between the opposed surfaces 3, and the quantity of the conductor 2 having a vector in the X-axis direction is increased. In the loop antenna 1 illustrated in FIG. 3, the magnetic field H_{X} in the X-axis direction is generated by the parts 11, 13 and 14, and 12, 19 and 20 of the conductor 2. Moreover, the magnetic field H_{Y} in the Y-axis direction is generated by the parts 11, 15 and 17, and 12, 16 and 18 of the conductor 2. Furthermore, the magnetic field H_{Z} in the Z-axis direction is generated by the parts 14, 15 and 22, 13, 17 and 11, 18, 19 and 21, and 16, 20 and 22 of the conductor 2.

The loop antenna 1 illustrated in FIG. 3 has such an advantage that the range of the generation of the magnetic field H_{X} in the X-axis direction and a magnetic field strength are more increased as compared with the loop antenna 1 illustrated in FIGS. 1 and 2. Therefore, there is such an advantage that the reliability and precision of a communication with a radio communication medium having an inclination angle with respect to the X axis can be enhanced. As a matter of course, the magnetic field can be applied to all of the X axis, the Y axis and the Z axis in the same manner as in the loop antenna 1 shown in FIGS. 1 and 2. Consequently, there is such an advantage that the reliability and precision of the communication can be enhanced irrespective of the position and direction of the radio communication medium present in a region formed by the loop antenna 1.

FIG. 4 illustrates the loop antenna 1 having a further shape.

The conductor 2 of the loop antenna 1 illustrated in FIG. 4 has a plurality of bending portions 50, and a region space formed by the conductor 2 is provided in a three-dimensional space. More specifically, the bending portions 50 are formed by bending the conductor 2 turned circumferentially like a loop having a circumferential turn which is formed on almost the same plane in a plurality of portions. In the loop antenna 1 illustrated in FIG. 4, a central portion thereof is bent loosely to have an obtuse angle, and a middle portion at both sides of the central portion is bent to have an acute angle. Consequently, the conductor 2 can take an almost E shape seen from the Z axis.

In the loop antenna 1, a magnetic field can be applied in all of the directions of the X axis, the Y axis and the Z axis in the same manner as in the loop antenna 1 illustrated in FIGS. 1 to 3.

The magnetic field H_{X} in the X-axis direction is generated by the parts 11, 13 and 14, and 12, 19 and 20 of the conductor 2. The magnetic field H_{Y} in the Y-axis direction is generated by the parts 11, 15 and 17, and 12, 16 and 18 of the conductor 2, and the magnetic field H_{Z} in the Z-axis direction is generated by the parts 14, 15, 14 and 17 and the parts 18, 19, 16 and 20 of the conductor 2.

By the magnetic fields thus generated, the communication can be carried out reliably irrespective of the position and direction of the radio communication medium present in the vicinity of the loop antenna 1, particularly, a region formed by the loop antenna 1.

FIG. 5 also illustrates the loop antenna having a further shape.

The conductor 2 of the loop antenna 1 illustrated in FIG. 5 also forms a region space in a three-dimensional space by a plurality of bending portions 50. The loop antenna 1 has an almost M shape seen from the Z axis. The loop antenna 1 illustrated in FIG. 5 has a large number of bending portions 50 with respect to the Y axis, and the number of the parts of the conductor 2 applying a magnetic field in the Z-axis direction is increased. Consequently, there is such an advantage that the strength of the magnetic field H_{Z} generated from the Z axis can be increased and precision in a communication with the radio communication medium present with an inclination with respect to the Z axis can be enhanced.

The magnetic field H_{X} in the X-axis direction is generated by the parts 11, 13 and 14, and 12, 19 and 20 of the conductor 2. The magnetic field H_{Y} in the Y-axis direction is generated by the parts 11, 15 and 17, 12, 16 and 18, and 21 and 22 of the conductor 2. Furthermore, the magnetic field H_{Z} in the Z-axis direction is generated by the parts 14, 15, 13, 17, 14, 22, 13, 21, 18, 19, 16, 20, 19, 21, 20 and 22 of the conductor 2. Thus, a magnetic field can be generated in all of the X axis, the Y axis and the Z axis through the loop antenna 1. Therefore, it is possible to carry out the communication with high precision irrespective of the position and direction of the radio communication medium present in a region space formed by the loop antenna 1.

These loop antennas 1 can generate regions taking the shape of a polyhedron, for example, a hexahedron, a sphere or an ellipse through the loop shape having the bending. Furthermore, it is also possible to apply the magnetic field in all of the X axis, the Y axis and the Z axis in the region spaces which are generated. Consequently, the communication can be carried out irrespective of the position and direction of the radio communication medium present in each of these region spaces. Therefore, the loop antenna 1 can be suitably used in a radio communication medium processing device which is provided in the housing such as a box, a rack or a basket and can reliably carry out the communication with the radio communication medium present in the internal space of the housing. As a matter of course, the loop antenna 1 is not simply used in the radio communication medium processing device.

By the above structure, it is possible to implement a loop antenna capable of applying a magnetic field to all of the X axis, the Y axis and the Z axis in the region formed by the conductor.

### Second Embodiment

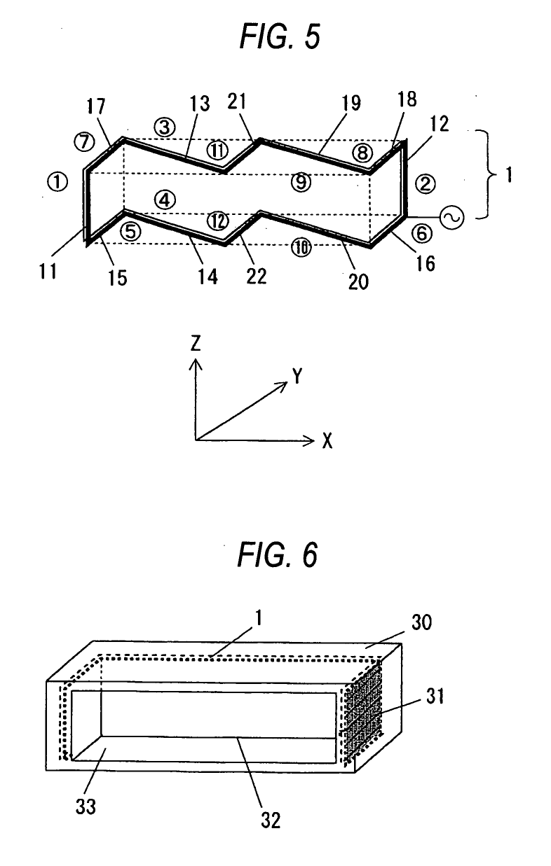

FIG. 6 is a perspective view showing a radio communication medium processing device according to a second embodiment of the invention. 30 denotes a housing, 31 denotes a reading/writing portion, 32 denotes an internal space and 33 denotes an opening portion. The housing 30 is a structure formed by the internal space 32 and the opening portion 33 connecting an external space, and a rectangular parallelepiped is illustrated in FIG. 6 and is not restricted thereto but may be a sphere, a cube or a polyhedron. By the housing 30, it is possible to store a product having a radio communication medium attached to an inner part. The housing 30 may be used singly or in piles. Moreover, the opening portion 33 may be perfectly opened as shown in FIG. 6 or may be hidden by an openable door or a partition cloth. Furthermore, a cover for preventing an inner part from being deteriorated may be provided for a circulation in a manufacture and may be removed in an actual use. By the presence of the opening portion 33, it is easy to accommodate the product in the internal space 32 and to take the product out of the internal space 32. While the opening portion 33 is provided in a front part and corresponds to use for a so-called rack in FIG. 6, moreover, it may be provided in an upper part to correspond to use for a basket or a box.

The loop antenna 1 is provided in the housing 30 and may be provided along the internal space 32 or may be incorporated in a partition plate forming the housing 30. The shape of the loop antenna 1 may be any of those described with reference to FIGS. 1 to 5. It is sufficient that the loop antenna 1 is formed by a conductor having a three-dimensional bending portion 50 and turned circumferentially like a loop and can apply a magnetic field to all of an X axis, a Y axis and a Z axis in the region space.

While it is sufficient that the material of the partition plate for forming the housing 30 can maintain a normal strength, an eddy current is generated by an electromagnetic wave emitted from the loop antenna 1 if the partition plate is formed by a conductor such as a metal. Consequently, a loss is made. Therefore, it is desirable that a material other than a conductor such as a metal should be used.

The reading/writing portion 31 has a function of carrying out a processing for giving a current and data to a radio communication medium in order to start the radio communication medium and performing the authentication of an ID code and the detection of an error, for example, by receiving data from the radio communication medium and demodulating the received data. By the processing of the reading/writing portion 31, it is possible to recognize the radio communication medium present in the internal space 32 of the housing 30. For example, there is implemented a stock management for the degree of residual products having a radio communication medium such as an IC tag attached thereto in the housing 30 used as a product rack. The reading/writing portion 31 is incorporated in the housing 30. The reading/writing portion 31 may be provided in the internal space 32 of the housing 30, may be fitted in a part of the partition plate or may be provided on the outside of the housing 30.

As described in the first embodiment, the loop antenna 1 can apply a magnetic field to all of the X axis, the Y axis and the Z axis in a region formed by the conductor 2. Therefore, it is possible to apply a magnetic field irrespective of the position and direction of the radio communication medium present in the region space.

Only the loop antenna 1 may be provided in the housing 30. In this case, the reading/writing portion 31 may be externally connected to the housing 30 provided with only the loop antenna 1 and a magnetic member may be provided around the loop antenna 1 if necessary, and furthermore, a shield may be formed on the outside of the magnetic member. The magnetic member is provided in abutment on or close to the periphery of the loop antenna 1 so that the closed circuit of a magnetic field is formed together with the loop antenna 1. Consequently, it is possible to increase a magnetic field strength and to enhance a communication distance and a communication strength with the radio communication medium. Moreover, the shield is provided so that a magnetic field is closed into only the three-dimensional space formed by the loop antenna 1. Consequently, it is possible to prevent a magnetic field from leaking out. Thus, it is possible to prevent the magnetic field from being supplied to the radio communication medium present on the outside of the housing 30.

Any or all of the loop antenna 1, the magnetic member and the shield may be formed integrally with the member forming the housing 30 or they may be formed separately. Moreover, the shield may be formed by coating the outer peripheral surface of the housing 30 with a metal paste, a metal film or a metal plate. Alternatively, the shield may be formed by a metal case for storing the housing 30 therein. Moreover, the magnetic member may be formed by coating the internal surface of the housing 30 with a magnetic material or sticking a magnetic plate. As a matter of course, a case formed by the magnetic member may be stored in the housing 30. Alternatively, the loop antenna 1 and the magnetic member may be formed integrally.

While the loop antenna 1 may be formed by the conductor, moreover, it may be formed in the housing 30 through pattern printing or may be formed on the magnetic member through pattern printing.

Next, description will be given to the operation of the radio communication medium processing device in the case in which an IC tag or an IC card is used as the radio communication medium.

First of all, a necessary signal current is supplied from the reading/writing portion 31 to the loop antenna 1. The signal current thus supplied is generated as a magnetic field from the loop antenna 1. In the case in which a product having an IC tag or an IC card attached thereto is present in the internal space 32 of the housing 30, for example, an induced electromotive force is generated in the antenna incorporated in the IC tag or the IC card upon receipt of a magnetic field from the loop antenna 1. Consequently, a power and signal data are supplied to an IC incorporated in the IC tag or the IC card. A load fluctuation is generated in a modulating circuit constituted by a switch and a load circuit corresponding to data sent from a loaded memory in the IC tag to which the power is supplied, and is transmitted to the loop antenna 1 through a mutual inductance. The load fluctuation is received as a signal in the loop antenna 1 and is transmitted as a received signal to the reading/writing portion 31. In the reading/writing portion 31, the same signal is demodulated and an error detection is carried out if necessary, thereby analyzing a signal sent from the IC tag. Upon receipt of the result of the analysis, for example, it is possible to grasp the degree of the presence of any product in the housing 30. In particular, the loop antenna 1 capable of applying a magnetic field in all of the directions of the X axis, the Y axis and the Z axis is incorporated. Consequently, it is possible to carry out a recognition irrespective of the direction and position of the radio communication medium present in the internal space 32. Thus, it is possible to constitute an optimum radio communication medium processing device for carrying out a merchandize management.

In order to reduce an erroneous recognition, it is also suitable to carry out a processing of an error detection and a retransmission request and an error correction in the reading/writing portion 31. A cyclic code check and a parity check are suitable for the error detection. Viterbi decoding and Reed-Solomon decoding are suitable for the error correction.

It is also desirable that the reading/writing portion 31 should be provided with a communicating portion to be used for transmitting demodulated data or receiving data to be transmitted to an IC tag. Consequently, it is possible to carry out a communication with a host machine to be the server of the radio communication medium processing device. Thus, it is possible to assemble a more advanced system having a higher use value.

As described above, in the case in which the housing is utilized as a product basket or a product rack, it is possible to properly carry out a merchandize management.

In the case in which the goods are medicines, for example, a name, a term of validity and a due date of delivery are preset to the IC tag to be attached to these goods. In the case in which the housing 30 is utilized as a medicine storage rack, the stock control of the medicines can easily be carried out. For example, it is possible to previously discard a medicine having a term of validity which is expired very soon and to confirm, through only a storage, the degree of any medicine which remains. In the case in which the goods are books or foodstuffs, similarly, the same processing can be carried out. Therefore, it is possible to produce an advantage that a stocktaking efficiency can be enhanced very greatly.

In the case in which the housing 30 is not utilized as a rack but a basket at this time, it is possible to calculate an amount of money by utilizing the housing 30 as a shopping bag and simply putting the goods having the IC tag attached thereto in the shopping bag, for example. In this case, a service of shopping can be enhanced.

Also in this case, it is possible to carry out a recognition irrespective of the direction and position of the radio communication medium present in the internal space through the loop antenna 1. Consequently, it is possible to execute a processing having high precision and reliability.

By the above structure, it is possible to carry out a communication with the radio communication medium present in the housing by utilizing the box-shaped radio communication medium processing device as a rack or a basket, thereby applying to a merchandize management.

Moreover, it is also suitable to carry out a centralized processing by transmitting the data processed in the radio communication medium processing device by an installed radio unit to a host machine such as a server and to perform a remote operation by transmitting an instruction from the server to the radio communication medium processing device.

The invention provides a loop antenna comprising a conductor, a plurality of bending portions 50 provided on the conductor, and a feeding portion for supplying a signal current to the conductor, the conductor being turned circumferentially like a loop by setting the feeding portion to be a base point, wherein the conductor forms a three-dimensional space. By such a structure, a magnetic field generated from a loop antenna can generate a magnetic field in all axial directions in a three-dimensional space, and the magnetic field can be applied irrespective of the position and direction of a radio communication medium present in a space surrounded by the loop antenna. Thus, the invention can also be applied to uses in which a communication with the radio communication medium is to be performed reliably.

### Second Embodiment

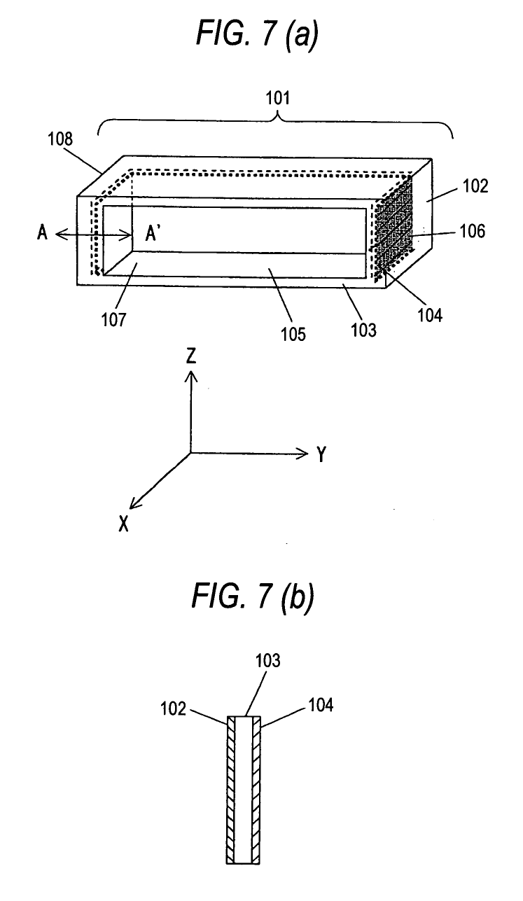

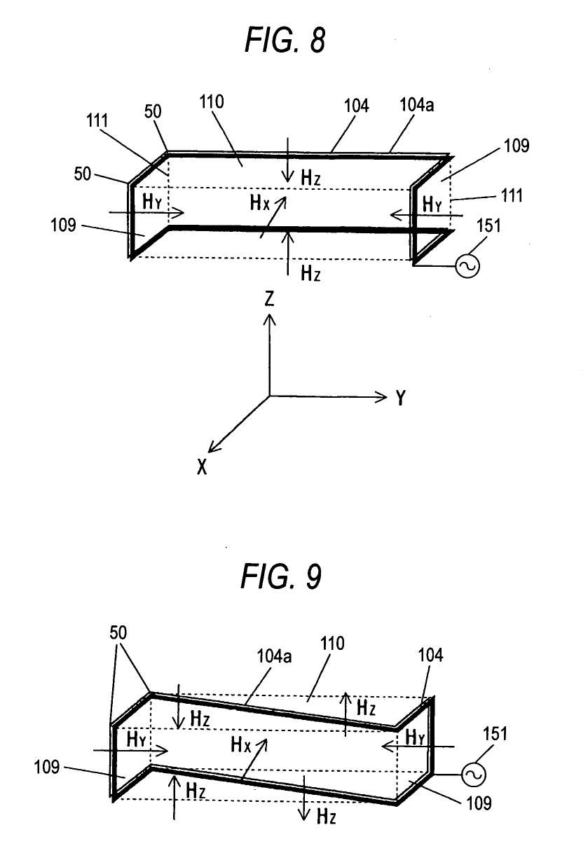

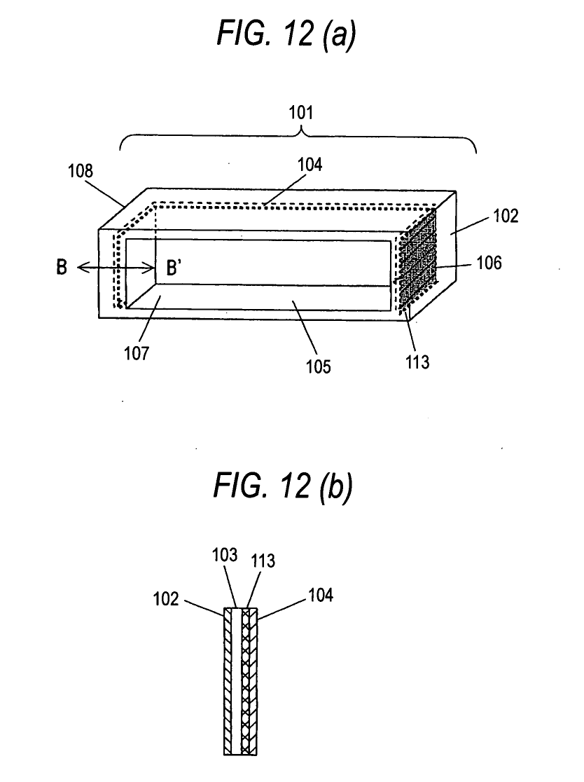

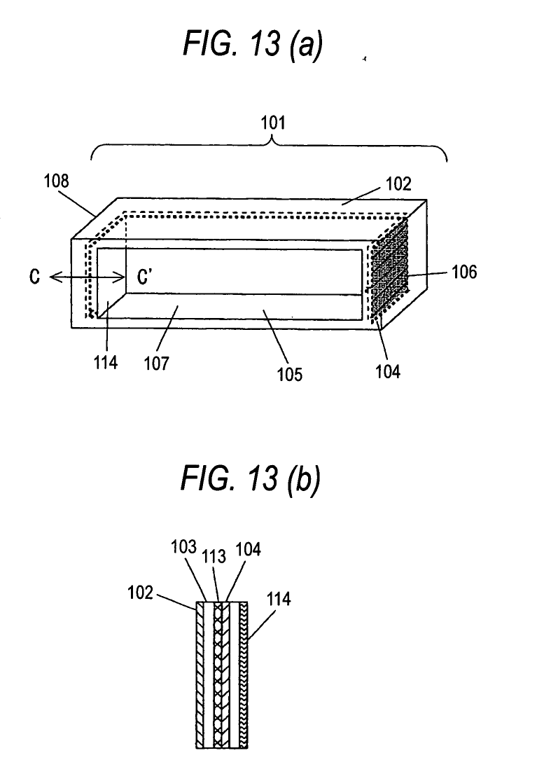

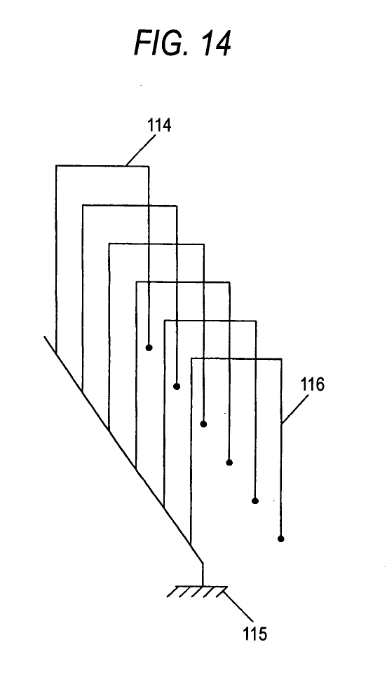

FIG. 7(a) is a perspective view showing a radio communication medium processing device according to a first embodiment of the invention, and FIG. 7(b) is a sectional view taken along A-A in (a). FIGS. 8, 9, 10 and 11 are perspective views showing an antenna to be incorporated in the radio communication medium processing device according to the first embodiment of the invention. FIG. 12(a) is a perspective view showing the radio communication medium processing device according to the first embodiment of the invention, FIG. 12(b) is a sectional view taken along B-B′ in (a), FIG. 13(a) is a perspective view showing the radio communication medium processing device according to the first embodiment of the invention, and FIG. 13(b) is a sectional view taken along C-C′ in (a). FIG. 14 is a perspective view showing an electric field shield according to the first embodiment of the invention. 101 denotes a radio communication medium processing device, 102 denotes a shield, 103 denotes a partition plate, 104 denotes an antenna, 105 denotes an internal space, 106 denotes a reading/writing portion, 107 denotes an opening portion, and 108 denotes a housing. X, Y and Z axes shown in FIG. 7(a) are orthogonal axes which are orthogonal to each other and indicate a three-dimensional space, and correspond to the radio communication medium processing device 101.

The radio communication medium processing device 101 is constituted by the housing 108 taking the shape of a hexahedron in which one surface forms the opening portion 107 by the partition plate 103 having five surfaces, and is provided with the internal space 105 and things can be accommodated in and taken out of the internal space 105 through the opening portion 107. More specifically, the radio communication medium can be accommodated in or taken out of the internal space 105 of the housing 108. The housing 108 may be adapted to use as a so-called rack in which the opening portion 107 is provided on a front surface as shown in FIG. 7(a) and the radio communication medium can be accommodated in and taken out of a forward part or may be adapted to use as a so-called basket in which the opening portion 107 is provided on an upper surface. While the opening portion 107 is provided on one surface in FIG. 7, moreover, it may be provided on two surfaces or more if necessary. While the housing 108 is constituted by the hexahedron, furthermore, other shapes may be taken.

While a hexahedron which is convenient for a plurality of arrays is used for the housing 108, furthermore, others may be employed and various structures such as a spherical shape, a polygonal shape and a cylindrical shape may be used in place of the shape of a box.

The opening portion 107 does not need to be always opened in the actual use of the radio communication medium processing device 101 but may be covered with an openable curtain or an openable lid or door may be provided, for example. Alternatively, a thin paper may be hung on the opening portion 107 to put goods having the radio communication medium attached thereto in/out of the internal space 105 and to be a blind for the goods in an inner part. Consequently, it is possible to hide the goods in an actual use or to prevent the goods from being dropped from the opening portion 107. As a matter of course, one surface of the housing 108 may be opened perfectly as shown in FIG. 7. Moreover, a lid for preventing a deterioration in an inner part is provided to carry out a circulation in a manufacture and the lid may be removed in an actual use.

While it is sufficient that the material of the partition plate 103 forming the housing 108 can maintain a normal strength, moreover, an eddy current is generated by an electromagnetic wave generated from the loop antenna 104 if the partition plate 103 is formed by a conductor such as a metal. Consequently, a loss is made. Therefore, it is desirable to use a material other than the conductor such as a metal. If an interval in a portion in which the shield 102 and the loop antenna 104 are close to each other is too small, the eddy current is generated to make a loss in the shield 102 through a magnetic field generated from the loop antenna 104 and a communication capability with the radio communication medium is impeded by the loss. For this reason, the interval between the shield 102 and the loop antenna 104 is to be constant or more. In the case in which the thickness of the partition plate 103 is adapted to the interval, a corresponding thickness is required for the partition plate 103.

The shield 102 prevents the leakage of the electromagnetic wave generated from the loop antenna 104. Consequently, the electromagnetic wave generated from the loop antenna 104 provided in the housing 108 can be prevented from penetrating through and leaking out of the partition plate 103 of the housing 108. The electromagnetic wave does not leak to the adjacent radio communication medium processing device 101 when a plurality of radio communication medium processing devices 101 is stacked to be used, for example, and the radio communication medium present in another housing 108 can be thus prevented from being recognized erroneously. Herein, it is desirable that the shield 102 should be formed by a metal material for preventing the leakage of the electromagnetic wave. In particular, aluminum is suitable in respect of a durability or a lightness. Moreover, the shield 102 may be formed to cover all of the external surfaces of the housing 108, that is, five surfaces other than the opening portion 107. Also in the case in which the radio communication medium processing devices 101 are stacked, an electromagnetic wave can be prevented from leaking to any adjacent housing 108. Therefore, the degree of freedom to combine the radio communication medium processing devices 101 can be increased very greatly.

While the housing 108 may be formed to have the external surfaces covered, moreover, a shield layer may be formed on the internal layer of the partition plate 103 forming the housing 108 because it is an object to prevent an electromagnetic wave radiated from the loop loop antenna 104 from leaking beyond the external wall of the housing 108.

Furthermore, the housing 108 may be formed by a shield material or may be formed by containing a material component having a shield function therein.

In addition, the loop loop antenna 104 may be formed integrally with the magnetic member or the housing 108, or may be formed on the surface of the magnetic member or the housing 108 through pattern printing.

On the other hand, in the case in which two radio communication medium processing devices 101 are simply arranged side by side, an electromagnetic wave leaking from side surfaces which are not provided adjacently but apart from each other rarely becomes a problem. The shield 102 can also be omitted from these surfaces. It is preferable that the shield 102 should be formed if necessary.

In the case in which the radio communication medium processing device 1 is to be used as a unit, the shield 102 does not need to be formed.

On the other hand, in the case in which two radio communication medium processing devices 101 are simply arranged side by side, electromagnetic waves leaking from side surfaces which are not provided adjacently but apart from each other rarely become a problem. Therefore, the shield 2 can also be omitted from these surfaces. It is preferable that the shield 102 should be formed if necessary.

Moreover, the shield 102 may have the surface of the partition plate 103 coated with a metal paste or may have a metal plate or a metal film stuck thereto. Alternatively, a metal case taking the shape of a box may be previously formed to accommodate the housing 108 therein. As a matter of course, it is desirable that the shield 102 should be formed corresponding to a shape if the housing 108 is not the hexahedron having the opening portion 107.

The loop antenna 104 can carry out a communication with a radio communication loading medium and is connected to the reading/writing portion 106. While the loop antenna 104 takes various shapes, it is desirable that an electromagnetic induction in a radio communication medium should be generated in all of the places of the internal space 105 in order to reliably carry out the communication with the radio communication medium present in the internal space 105 of the housing 108. Therefore, it is desirable that the loop antenna 104 should generate a magnetic field to all of the X, Y and Z axes in the internal space 105.

A non-feeoding loop antenna is accommodated in the partition plate 103 so that there is produced such an advantage as to extend a communication distance. A current also flows to the non-feeding antenna through the electromagnetic induction generated from the loop antenna 104 so that the non-feeding antenna is operated as an antenna. Consequently, it is possible to produce such an advantage as to enlarge a communication range. Therefore, the amount of the current to be supplied to the loop antenna 104 can be reduced so that a consumed power can be decreased. At this time, the non-feeding antenna may be stored in each of the surfaces of the partition plate 103 or an optional surface. While the non-feeding antenna may be stored in the partition plate 103, moreover, it may be provided on the outside of the partition plate 103 between the loop antenna104 and the shield 102.

The loop antenna 104 illustrated in FIG. 8 has such a structure as to generate a magnetic field to all of the X, Y and Z axes in the internal space 5. In FIG. 8, a portion which is turned circumferentially like a loop and is shown in a thick line indicates a conductor 104a, and a feeding point 151 is connected to the end of the conductor 104a and the conductor 104a is connected to a reading/writing portion 106 through the feeding point 151. Moreover, a signal current is supplied from the feeding point 151 to the conductor 104a so that the radiation of a magnetic field can be implemented.

110 denotes an optional surface and 109 denotes surfaces present on both ends of the optional surface 110, and they correspond to the back and side surfaces of the housing 108, respectively. 111 denotes an intersection of the optional surface 110 and the both end surfaces 109. The conductor 104a of the loop antenna 104 is connected with a circumferential turn around the sides of the optional surface 110 and the both end surfaces 109 other than the side of the intersection 111 and takes a so-called loop shape in a single stroke. Therefore, a magnetic field H_{X} for the X axis is generated in a perpendicular conductor portion to the X axis, a magnetic field H_{Y} for the Y axis is generated in a perpendicular conductor portion to the Y axis and a magnetic field H_{Z} for the Z axis is generated in a perpendicular conductor portion to the Z axis, and the magnetic field can be generated in all of three-dimensional directions in all of the places of the internal space 105. Consequently, the electromagnetic induction can be generated by the loop antenna 104 and a recognition can be carried out reliably irrespective of the position and direction of the radio communication medium present in the internal space 105.

A null point to be a cancellation by a magnetic field having a vector and a magnitude in an opposite direction is generated in just the middle of the both end surfaces 109. Therefore, a radio communication medium present in this portion cannot be recognized. In order to correspond thereto, it is suitable to previously provide an obstacle for putting the radio communication medium in a portion in which the magnetic field of the internal space 105 of the housing 108 generates the null point. Consequently, it is possible to remarkably reduce the radio communication medium present in the internal space 105 which cannot be recognized.

Next, the loop antenna 104 shown in FIG. 9 has the conductor 104a taking the shape of a loop which is constituted like Z seen from the Z axis, and is loop-shaped to connect each of the sides of the optional surface 110 and the both end surfaces 109 in the same manner as in the loop antenna 104 in FIG. 8 and takes such a shape as to be turned circumferentially by passing through all of four vertexes of the both end surfaces 109. Similarly, the loop antenna 104 shown in FIG. 9 generates the magnetic fields H_{X}, H_{Y} and H_{Z} for the X, Y and Z axes, respectively. Consequently, the communication can be carried out irrespective of the position and direction of the radio communication medium present in the internal space 105. Moreover, the conductor portion provided along the Y axis is formed like a diagonal line on the bottom and upper surfaces of the housing 108. Therefore, a magnetic field distribution in the depth direction of the internal space 105, that is, the X-axis direction can be averaged. Thus, a communication capability with the radio communication medium can be enhanced.

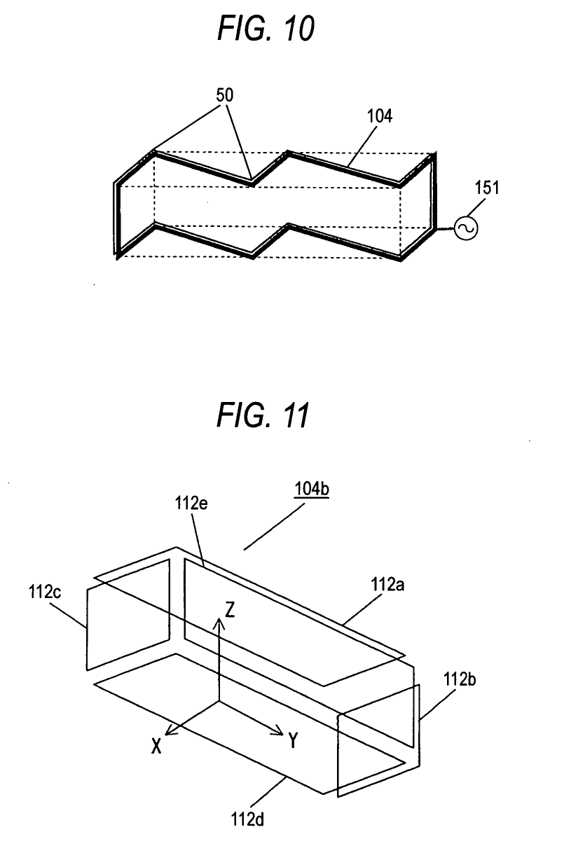

The loop antenna 104 shown in FIG. 10 is a loop-shaped antenna constituted like W seen from the Z axis, and generates a magnetic field toward the X, Y and Z axes in the same manner.

The loop antenna 104 may be formed along the internal surface of the partition plate 103 in the internal space 105 or may be formed integrally with the partition plate 103.

While there has been described that the loop antenna 104 is a loop antenna having one feeding point to be a base point in FIGS. 8, 9 and 10, it is a matter of course that the loop antenna 104 may be constituted by a plurality of loop antennas present independently on each of the surfaces of the housing 108.

FIG. 11 illustrates the loop antenna device 104b constituted by a plurality of loop antennas. 112a, 112b, 112c, 112d and 112e denote loop antennas which are connected to independent feeding points and are formed along surfaces other than the opening portion 107 of the housing 108, respectively. By the loop antennas, a three-dimensional space is formed. Also in this case, a magnetic field is generated for the X axis, the Y axis and the Z axis in the internal space 105 to be the three-dimensional space thus formed so that a communication can be carried out irrespective of the position and direction of the radio communication medium present in the internal space 105. Even if any of the loop antennas 112a to 112e is set to be feeding and the others are set to be non-feeding, moreover, it is possible to produce such an advantage that the same operation can be carried out and a consumed power can be reduced. Therefore, it is also preferable that a power should be fed to only a part of the loop antennas and should not be fed to the residual loop antennas. In this case, it is necessary to set, to be the non-feeding, the loop antenna present adjacently to the loop antenna to which the power is fed. It is preferable that the power should be fed to only the loop antenna 112e in respect of consumed power saving.

In the case in which the loop antenna 104 is constituted by the loop antennas 112a to 112e, it is possible to enhance a communication performance and to increase precision in a recognition by providing selecting means such as a switch for selecting and receiving any of the loop antennas which has the highest power.

FIGS. 12(a) and 12(b) illustrate the radio communication medium processing device 101 in the case in which a magnetic plate is provided. 113 denotes a magnetic plate which is provided between the loop antenna 104 and the partition plate 103. While a magnetic field is generated from the loop antenna 104, an eddy current is usually generated in the shield 102 formed by a metal material through the generated magnetic field. Since the eddy current generates a magnetic field having such a vector as to cancel the magnetic field of the loop antenna 104, it impedes the communication capability of the loop antenna 104. Moreover, an impedance fluctuates so that impedance matching might also be changed. In order to prevent the generation of the eddy current, it is necessary to sufficiently maintain an interval between the loop antenna 104 and the shield 102. For this reason, it is necessary to increase the thickness of the partition plate 103 which produces the interval. Consequently, the size and weight of the housing 108 is increased so that a reduction in the size and a decrease in the weight are hindered in some cases.

On the other hand, the magnetic plate 113 is provided adjacently to the loop antenna 104 between the loop antenna 104 and the shield 102. Consequently, a closed circuit is formed between the magnetic plate 113 and the loop antenna 104 so that an extra magnetic field can be prevented from leaking out of the magnetic plate 113. Therefore, it is possible to produce such an advantage that an eddy current can be prevented from being generated in the shield 102 and an unnecessary loss can be prevented from being generated. It is desirable that the magnetic plate 113 should be provided to come in close contact with the loop antenna 104. Consequently, the function of preventing a magnetic field generated from the loop antenna 104 from leaking out of the magnetic plate 113 can be enhanced most greatly. For this reason, it is desirable that the loop antenna 104, the magnetic plate 113, the partition plate 103 and the shield 102 should be provided in this order from the inside of the housing 108 as illustrated in FIG. 12(b).

FIGS. 13(a) and 13(b) illustrate the radio communication medium processing device 101 in the case in which an electric field shield is provided. 114 denotes an electric field shield. The electric field shield 114 has the function of transmitting a magnetic field generated from the loop antenna 104 and preventing the leakage of an electric field generated from the loop antenna 104. For this reason, a magnetic field is generated from the loop antenna 104 to the internal space 105. The generation of an induced electromotive force to the radio communication medium is not influenced, and the electric field is blocked while the communication with the radio communication medium is maintained. Therefore, the electric field can be prevented from leaking out of the opening portion 107 of the housing 108. Consequently, it is possible to easily achieve a so-called electric field regulation.

FIG. 8 illustrates an electric field shield 114. 115 denotes a ground point and 116 denotes a conductor. The conductor 116 is so-called bag-shaped and is arranged like a comb, and one of the ends of the conductor 116 arranged like the comb is connected to the ground point 115 and the other is opened. The electric field shield 114 thus formed is provided on the inside of the loop antenna 104, that is, in a position interposed between the internal space 105 and the loop antenna 104. Consequently, it is possible to reduce the leakage of the electric field to an outside. Thus, it is possible to take a countermeasure against an electric field regulating method. It is desirable that the electric field shield 114 should be provided at an optional interval from the loop antenna 104. Moreover, the electric field shield 114 may be provided in only a portion of the loop antenna 104 which is close to the opening portion 107, for example. Consequently, it is possible to at least prevent the electric field from leaking from the opening portion 107 to an external space, thereby exceeding the electric field regulation, and furthermore, to reduce a cost. Therefore, it is possible to achieve an advantage by provision on only both side-surfaces of the opening portion 107 of the housing 108, for example.

The reading/writing portion 106 supplies a signal to the radio communication medium, and demodulates the received signal and detects an error through the loop antenna 104. By the processing of the reading/writing portion 106, it is possible to recognize the radio communication medium present in the internal space 105 of the housing 108. For example, it is possible to implement a merchandise management for checking the degree of the residual goods having a radio communication medium such as an IC tag attached thereto in the housing 108 to be used as a rack for the goods. The reading/writing portion 106 is incorporated in the housing 108. The reading/writing portion 106 may be provided in the internal space 105 of the housing 108 or may be fitted in a part of the partition plate 103.

The loop antenna 104, the magnetic plate 113, the electric field shield 114 and the shield 102 may be formed integrally with the partition plate 103 constituting the housing 108 respectively or may be formed separately. Moreover, the partition plate 103 corresponding to each surface is previously formed, the conductor having the shield 102, the magnetic plate 113, the electric field shield 114 and the loop antenna 104 is formed on the partition plate 103, and furthermore, the partition plate 103 is assembled to fabricate the housing 108 having one surface to be the opening portion 107, and the reading/writing portion 106 is incorporated in the housing 108. Thus, the radio communication medium processing device 101 is constituted.

Next, description will be given to the operation of the radio communication medium processing device 101 in the case in which an IC tag or an IC card is used as the radio communication medium.

First of all, a necessary signal current is supplied from the reading/writing portion 106 to the loop antenna 104. The signal current thus supplied is generated as a magnetic field from the loop antenna 104. In the case in which goods having an IC tag or an IC card attached thereto are present in the internal space 105 of the housing 108, for example, an induced electromotive force is generated in the antenna incorporated in the IC tag or the IC card upon receipt of a magnetic field from the loop antenna 104. Consequently, a power and signal data are supplied to an IC incorporated in the IC tag or the IC card. A load fluctuation is generated in a modulating circuit constituted by a switch and a load circuit corresponding to data sent from a loaded memory in the IC tag to which the power is supplied, and is transmitted to the loop antenna 104 through a mutual inductance. The load fluctuation is received as a signal in the loop antenna 104 and is transmitted as a received signal to the reading/writing portion 106. In the reading/writing portion 106, the same signal is demodulated and an error detection is carried out if necessary, thereby analyzing a signal sent from the IC tag. Upon receipt of the result of the analysis, for example, it is possible to grasp the degree of the presence of any product in the housing 108. Moreover, the shield 102 is provided over the external surface of the housing 108. Therefore, the magnetic field of the loop antenna 104 present in one housing 108 can be prevented from leaking to another housing. Consequently, the radio communication medium present in another close housing 108 can be prevented from being recognized erroneously.

In order to reduce an erroneous recognition, it is also suitable to carry out a processing of an error detection and a retransmission request and an error correction in the reading/writing portion 106. A cyclic code check and a parity check are suitable for the error detection. Viterbi decoding and Reed-Solomon decoding are suitable for the error correction.

It is also desirable that the reading/writing portion 106 should be provided with a communicating portion to be used for transmitting demodulated data or receiving data to be transmitted to an IC tag. Consequently, it is possible to carry out a communication with a host which will be described below. Thus, it is possible to assemble a more advanced system having a higher use value.

As described above, in the case in which the housing 108 is utilized as a product basket or a product rack, it is possible to properly carry out a merchandize management.

In the case in which the goods are medicines, for example, a name, a term of validity and a due data of delivery are preset to the IC tag to be attached to these goods. In the case in which the housing 108 is utilized as a medicine storage rack, the stock control of the medicines can easily be carried out. For example, it is possible to previously discard a medicine having a term of validity which is expired very soon and to confirm, through only a storage, the degree of any medicine which remains. In the case in which the goods are books or foodstuffs, similarly, the same processing can be carried out.

At this time, it is also possible to set the radio communication medium processing device 101 for carrying out an independent radio communication medium authentication to be one unit on the basis of one housing 108, thereby utilizing the same radio communication medium processing device 101 as a plurality of assembled racks for goods. For example, they are arranged in a matrix. At this time, the shield 102 is provided on the external surface of each radio communication medium processing device 101. Also in the case in which the radio communication medium processing devices 101 are stacked, therefore, the magnetic field generated from the loop antenna 104 of the radio communication medium processing device 101 does not leak to another radio communication medium processing device 101 but the radio communication medium present in another housing 108 can be prevented from being recognized erroneously. By setting the radio communication medium processing devices 101 provided with the shields 102 to be one unit, thus, it is possible to easily constitute a rack having a higher accommodating property, and furthermore, to individually carry out the merchandize management in each of them. In the case in which a how-to book is put in the radio communication medium processing device 101 to be a certain rack and a pocketbook is put in the radio communication medium processing device 101 to be another rack as a showcase combining a plurality of book-shaped members, for example, the merchandise management can be individually carried out so that it is possible to produce such an advantage as to enhance the efficiency of stocktaking very greatly.

In the case in which the housing 108 is not utilized as a rack but a basket at this time, it is possible to calculate an amount of money by utilizing the housing 108 as a shopping bag and simply putting the goods having the IC tag attached thereto in the shopping bag, for example. In this case, a service of shopping can be enhanced.

By the above structure, it is possible to carry out a communication with the radio communication medium 101 present in the housing 108 by utilizing the radio communication medium processing device 101 of the housing 108 as a rack or a basket, thereby applying to a merchandize management. Moreover, the shield 102 is provided on the external surface of the housing 108. Consequently, it is possible to eliminate drawbacks that the communication with the radio communication medium exceeding the housing 108 cannot be carried out and a thing which does not need to be read by the radio communication medium processing device 101 is recognized erroneously. Therefore, a plurality of radio communication medium processing devices 101 of the housings 108 can be assembled and used. Consequently, it is possible to previously provide the radio communication medium processing device 101 of the housing 108 as one unit, thereby carrying out a merchandize management having a very high efficiency and a great flexibility.

### Third Embodiment

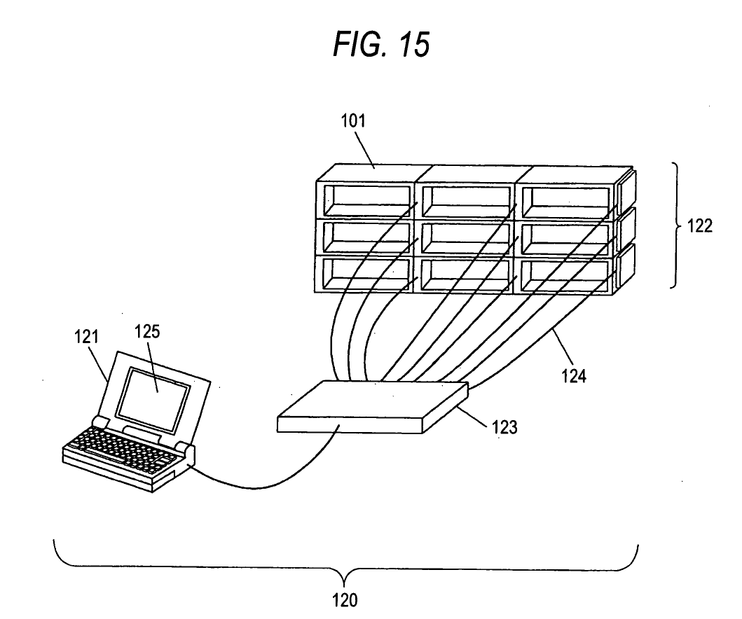

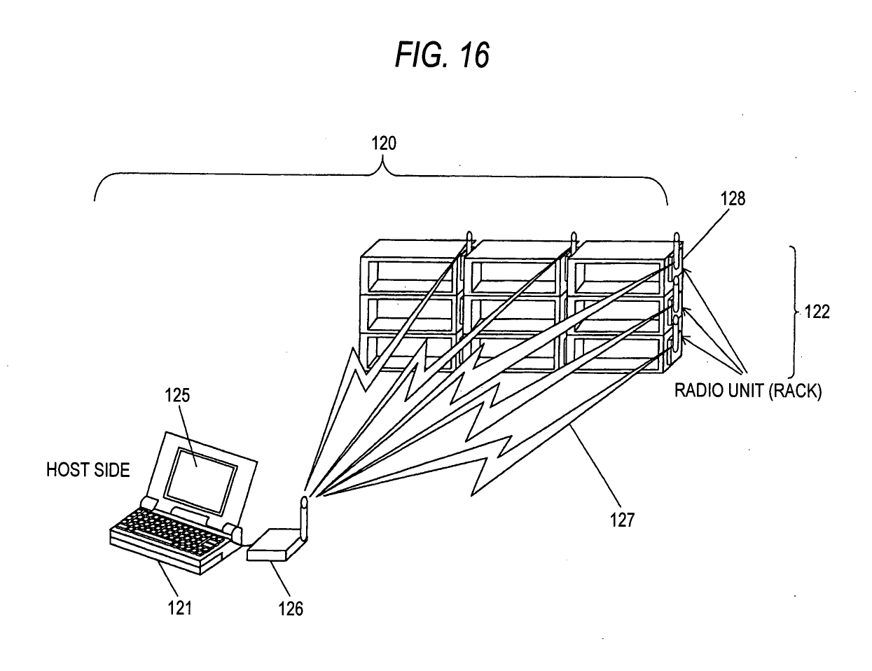

A third embodiment will be described with reference to FIGS. 15 and 16.

FIGS. 15 and 16 are views showing the structure of a radio communication medium processing system according to the second embodiment of the invention.

FIG. 15 shows the case in which a radio communication medium processing device 101 and a host are connected to each other through a wire communication. 120 denotes a radio communication medium processing system, 121 denotes a host, 122 denotes a processing device group, 123 denotes a set distributing device, 124 denotes a wire cable, and 125 denotes a display device.

The host 121 is a device capable of giving an instruction for the procedure of a communication and a processing, for example, a notebook computer, and it is desirable that the display device 125 for displaying a processing procedure and a processing result should also be provided close to the host 121. The processing device group 122 is obtained by assembling the radio communication medium processing device 101 to be the housing described in the first embodiment in a plurality of matrices. The radio communication medium processing devices 101 included in the processing device group 122 independently carry out a communication with the radio communication medium respectively, thereby authenticating an ID code given from the radio communication medium. Consequently, an individual merchandize management based on the radio communication medium present in the housing can be carried out in each radio communication medium processing device 101. Moreover, a communicating portion connected to a reading/writing portion 106 (not shown) is present in the radio communication medium processing device 101.

Each wire cable 124 is connected to the communicating portion present in the radio communication medium processing device 101 and is connected to the set distributing device 123. An Ethernet (R) cable capable of carrying out a data communication is used for the wire cable 124. Similarly, the set distributing device 123 and the host 121 are connected to each other by a wire and are connected to each other by a single cable because data are collected by the set distributing device 123.

The set distributing device 123 does not need to be provided but a plurality of wire cables 124 may be directly connected to the host 121. Moreover, a collecting device having an interface such as USB or RS232-C may be used for the set distributing device 123. For a data flow, furthermore, the transmission of an instruction from the host 121 to the processing device group 122 is used bidirectionally in addition to the transmission of a processing result from the processing device group 122 to the host 121.

Next, description will be given to the operation procedure of the system.

In the radio communication medium processing device 101, information possessed by the radio communication medium is received and analyzed by an exchange with the radio communication medium present in the housing. Consequently, it is possible to recognize the quantity of goods remaining in the housing in stock and an amount of money, for example. Also in another radio communication medium processing device 101, moreover, the merchandise management information can be recognized. At this time, the type of goods or information to be an object may be varied for each radio communication medium processing device. The information recognized in each radio communication medium processing device 101 is transmitted from the communicating portion to the set distributing device 123 in parallel through the wire cable. In the set distributing device 123, data transmitted from each radio communication medium processing device in parallel are aggregated and multiplexed, and are transferred to the host 121. Examples of the multiplexing include time division multiplexing and frequency division multiplexing. Alternatively, a plurality of data may be gathered together.

The multiplexed data which are transmitted to the host 121 are separated in the host 121 and individual results are recognized. Furthermore, a display is carried out by the display device 125 in a state in which a user can easily understand based on the result. For example, any of goods which are not enough and any of goods having an imminent term of validity are properly displayed in a graph from the merchandize management data transmitted from the radio communication medium processing device 101. By changing the processing means in the host 121, it is possible to switch a necessary display for a user.

While the data are once multiplexed in the set distributing device 123, all of the data may be received in the host 121 and a data processing may be carried out in parallel to display a result on the display device 125 in place of the multiplexing. Moreover, the set distributing device 123 may be constituted in the host 121.

To the contrary, the set distributing device 123 may also be used for transmitting an instruction from the host 121 to the radio communication medium processing device 101. For example, an instruction for stopping or restarting a processing in the optional radio communication medium processing device 101 in the processing device group 122 can be output from the host 121. In the case in which such a processing is to be carried out, there is no trouble that the power source of the communication medium processing device 101 in the processing device group 122 is turned OFF or a communication stop processing is carried out. A batch processing can be executed remotely from the host 121. In the case in which an optional time arrives, alternatively, it is also possible to give an instruction for operating the merchandize management. Thus, it is possible to construct a more user-friendly radio communication medium processing system.

FIG. 16 illustrates the case in which a communication between the radio communication medium processing device and the host is carried out by wireless. 126 denotes a radio unit on a host side, 127 denotes a radio transmission path, and 128 denotes a radio unit on a processing device side. The radio unit 128 is individually provided on each radio communication medium processing device 101, and transmits data processed in a reading/writing portion to the radio unit 126 on the host side and receives an instruction from the host 121 by wireless. Also in the case in which a radio communication is used in the communication with the host, the data processed by the radio communication medium processing device 101 are transmitted through the radio transmission path and are transferred to the host 121. In the host 121, based on the received data, a processing is carried out to obtain a state which can easily be seen by a user if necessary and a result is displayed on the display device 125. To the contrary, in the case in which the user is to transmit an instruction from the host 121 to the radio communication medium processing device 101, data are transferred from the radio unit 126 on the host side to the radio unit 128 on the processing device side and are processed in the radio communication medium processing device 101.

A modulating method such as a frequency modulation, an amplitude modulation or a phase modulation is used for a radio communication and a radio signal is transmitted and received through antennas provided on the radio units 126 and 128. In the case in which the radio communication is used, moreover, it is possible to enhance precision by using an error detection or an error correction. In FIG. 16, a radio wave is transmitted from the radio communication medium processing device 101 in parallel and is received by the radio unit 126. It is also suitable that each signal should be previously multiplexed and then transmitted to the host 121 by using a relay station.

Also in the case in which the radio communication is used, moreover, it is also possible to construct a system optimized for a situation by setting a mixing state using a cable communication in a part between the relay station and the radio unit 126 or the host 121.

In the case in which the radio communication is used, thus, it is possible to produce such an advantage that a wire cable does not need to be provided and the system can easily be constructed.

As described above, it is possible to constitute an optimum system for the merchandize management by constructing the processing device group 122 having a large number of radio communication medium processing devices 101 assembled and connecting the processing device group 122 to the host 121 through a cable communication or a radio communication. Since each of the box-shaped radio communication medium processing devices 101 has an external surface covered with the shield 102, moreover, there is no erroneous recognition of the radio communication media present in the different radio communication medium processing devices 101. In racks for goods which are constituted by a large number of radio communication medium processing devices 101, therefore, goods having different genres can be accommodated in the respective racks, and furthermore, various merchandize managements can be implemented (for example, a stock control in a certain rack and a term control in another rack). In addition, it is possible to construct a system capable of carrying out a batch management, a batch display and a batch processing in the host 121.

By such a structure that there are provided a housing constituted to have an internal space by a partition surface for dividing a space and formed by a hexahedron having one surface to be an opening portion, an antenna formed in the internal space of the housing, and a reading/writing portion for carrying out read/write from/to a radio communication medium through the antenna, and the external surface of the housing is covered with a shield excluding the opening potion thereof, it is possible to carry out a communication irrespective of the position and direction of a radio communication loading medium accommodated in the housing such as a box or a rack in the housing so that a merchandize management can be carried out reliably. By providing the shield on the external surface of the housing, it is possible to prevent an electromagnetic wave emitted from the antenna of a radio communication medium processing device from leaking to the adjacent housing. Consequently, a radio communication medium accommodated in the adjacent housing can be prevented from being recognized erroneously. Thus, it is also possible to apply to use requiring a reduction in an erroneous recognition rate in a merchandize management.

This application is based upon and claims the benefit of priority of Japanese Patent Application No2003-368667 filed on Mar. 10, 1929 and Japanese Patent Application of the No2003-384928 filed on Mar. 11, 1914, the contents of which are incorporated herein by reference in its entirety.

1. A loop antenna comprising:
a conductor, comprising a plurality of bending portions provided on the conductor, the conductor being turned circumferentially like a loop;
wherein the conductor forms a virtual three-dimensional space.

2. The loop antenna according to claim 1, wherein the loop antenna applies a magnetic field to a radio communication medium in the three-dimensional space or in the vicinity thereof.

3. The loop antenna according to claim 1, wherein the loop antenna applies a magnetic field to all of X, Y and Z axes which are orthogonal to each other.

4. The loop antenna according to claim 2, wherein the loop antenna applies a magnetic field to the radio communication medium, thereby carrying out a communication with the radio communication medium.

5. The loop antenna according to claim 1, wherein a feeding portion is provided on an end of the conductor.

6. The loop antenna according to claim 1, wherein the bending portion takes a square shape, an arc shape, a round shape or a curved shape or a combination between the square shape, the arc shape, the round shape or the curved shape.

7. The loop antenna according to claim 1, wherein a part of the conductor includes at least an arc shape or a straight shape.

8. The loop antenna according to claim 1, wherein the conductor has a conductor portion along all of X, Y and Z axes which are orthogonal to each other.

9. The loop antenna according to claim 1, wherein a portion of the conductor is present in at least one of a side, a surface and a diagonal line possessed by the virtual three-dimensional space formed by the conductor.

10. The loop antenna according to claim 1, wherein the conductor is formed on a side other than a side to be an intersection of two opposed surfaces and a surface interposed between the opposed surfaces in a polyhedral space to be the three-dimensional space formed by the conductor.

11. The loop antenna according to claim 1, wherein the conductor is present to connect all vertexes present in the virtual three-dimensional space formed by the conductor.

12. The loop antenna according to claim 1, wherein a center of gravity of the virtual three-dimensional space formed by drawing a straight line from an optional point of the conductor to the other portion of the conductor over the whole conductor is present in the virtual three-dimensional space.

13. The loop antenna according to claim 1, wherein the loop antenna comprises an opening surface, the opening surface being present across different planes where the opening surface crosses three-dimensionally.

14. The loop antenna according to claim 13, wherein the opening surface of the loop antenna includes a first surface, and second and third surfaces which are opposed to each other at both ends of the first surface.

15. The loop antenna according to claim 13, wherein the opening surface of the loop antenna is formed on almost the same plane.

16. The loop antenna according to claim 1, wherein a magnetic member is provided close to or in abutment on at least a part of the conductor forming the loop antenna.

17. The loop antenna according to claim 1, further comprising a housing for containing the loop antenna.

18. The loop antenna according to claim 17, wherein a magnetic member is provided between the loop antenna and the housing.

19. The loop antenna according to claim 17, wherein a shield is provided around the housing.

20. The loop antenna according to claim 17, wherein the housing is provided with an opening portion.

21. A loop antenna device comprising a plurality of loop antennas including an opening portion,
the loop antennas including a feeding loop antenna to which a signal current is supplied, and
a non-feeding loop antenna to which the signal current is not supplied,
wherein a virtual three-dimensional space is formed by the loop antennas.

22. The loop antenna device according to claim 21, wherein the loop antenna device applies a magnetic field to a radio communication medium in the three-dimensional space or in the vicinity thereof.

23. A radio communication medium processing device comprising:
a housing including an opening portion;
the loop antenna according to claim 1 which is provided in the housing or in a member forming the housing; and
a reading/writing portion for reading and/or writing data from/to a radio communication medium through the loop antenna.

24. The radio communication medium processing device according to claim 23, wherein a magnetic member is provided between the loop antenna and the housing.

25. The radio communication medium processing device according to claim 23, wherein a shield is provided around the loop antenna.

26. The radio communication medium processing device according to claim 25, wherein the shield is provided around the magnetic member.

27. The radio communication medium processing device according to claim 23, wherein the housing is a hexahedron, a box member or a rack member which has an opening portion on a part.

28. The radio communication medium processing device according to claim 23, wherein a feeding portion is provided on an end of the loop antenna.

29. The radio communication medium processing device according to claim 23, wherein the loop antenna applies a magnetic field to a radio communication medium in the housing.

30. The radio communication medium processing device according to claim 28, wherein the loop antenna applies a magnetic field to all of X, Y and Z axes which are orthogonal to each other.

31. The radio communication medium processing device according to claim 23, wherein a bending portion provided on the loop antenna takes a square shape, an arc shape, a round shape or a curved shape or a combination between the square shape, the arc shape, the round shape or the curved shape.

32. A radio communication medium processing device comprising:
a housing including an opening portion;
the loop antenna device according to claim 21 which is provided in the housing or in a member forming the housing; and
a reading/writing portion for reading and/or writing data from/to a radio communication medium through the loop antenna device.

33. The radio communication medium processing device according to claim 32, wherein a magnetic member is provided between the loop antenna device and the housing, and a shield is provided around the magnetic member.

34. The radio communication medium processing device according to claim 25, wherein the shield is an external surface of the housing, and the radio communication medium processing device is formed on at least an adjacent portion to the other radio communication medium processing device.

35. The radio communication medium processing device according to claim 25, wherein the shield is an external surface of the housing and is formed at all portions but the opening portion.

36. The radio communication medium processing device according to claim 25, wherein the shield is a metal case for containing the housing therein.

37. The radio communication medium processing device according to claim 25, wherein the shield has a predetermined interval in the closest portion to the loop antenna.

38. The radio communication medium processing device according to claim 37, wherein a predetermined interval between the shield and the antenna is maintained by a member forming the housing.

39. The radio communication medium processing device according to claim 23, wherein an electric field shield is provided in an inside of the loop antenna in an internal space of the housing.

40. The radio communication medium processing device according to claim 39, wherein the electric field shield is a bag-shaped comb type array conducting line including a comb type array to cover the loop antenna.

41. The radio communication medium processing device according to claim 23, wherein a part or all part of at least one of the loop antenna and the shield and the magnetic member and the electric field shield and the reading/writing portion is/are united with the housing.

42. The radio communication medium processing device according to claim 23, wherein an obstacle for impeding an installation of a radio communication medium is provided in a position to be a null point of a magnetic field generated from the loop antenna in an internal space of the housing.

43. The radio communication medium processing device according to claim 23, wherein the opening portion of the housing is provided with an openable or removable lid portion or cover portion.

44. The radio communication medium processing device according to claim 23, wherein a communicating portion for carrying out a communication with a server machine is connected to the reading/writing portion.

45. A radio communication medium processing system comprising:
a plurality of radio communication medium processing devices according to claim 44; and
a server machine for carrying out a control and a data processing for the radio communication medium processing devices,
wherein the radio communication medium processing devices are provided in a matrix and data sent from each of the radio communication medium processing devices are transmitted to the server machine through the communicating portion and are thus processed.

46. The radio communication medium processing system according to claim 45, wherein a communication between the radio communication medium processing device and the server machine which is carried out through the communicating portion is a cable communication.

47. The radio communication medium processing system according to claim 45, wherein a communication between the radio communication medium processing device and the server machine which is carried out through the communicating portion is a radio communication.

48. The radio communication medium processing system according to claim 45, wherein a data set distributing device is provided between the radio communication medium processing device and the server machine, and a communication between the radio communication medium processing devices and the server machine is carried out in parallel.

49. The radio communication medium processing system according to claim 45, wherein the server machine is provided with a display device for displaying a processing result received from the radio communication medium processing device.
